(19) United States
(12) Patent Application Publication
(10) Pub. No.: US 2026/0119412 A1
(43) Pub. Date: Apr. 30, 2026

(54) INTELLIGENT AUDIOVISUAL CONTROL SYSTEMS AND METHODS WITH LLM-BASED ROOM AGENT AND SPECIALIZED SUB-AGENT COORDINATION

(71) Applicant: QSC, LLC, Costa Mesa, CA (US)

(72) Inventors: Christopher Jaynes, Costa Mesa, CA (US); Matthew Skogmo, Placentia, CA (US); Daniel Allen, Erie, CO (US); Josh Foster, Meridian, ID (US); Derek Lieb, Boulder, CO (US)

(21) Appl. No.: 19/370,042

(22) Filed: Oct. 27, 2025

Related U.S. Application Data
(60) Provisional application No. 63/711,872, filed on Oct. 25, 2024.
(60) Provisional application No. 63/711,848, filed on Oct. 25, 2024.
(60) Provisional application No. 63/752,202, filed on Jan. 31, 2025.
(60) Provisional application No. 63/818,847, filed on Jun. 6, 2025.

(51) Int. Cl. G06F 13/10; G06Q 10/1093; G06V 30/10

(52) U.S. Cl. CPC G06F 13/10; G06Q 10/1093; G06V 30/10

(57) ABSTRACT

An intelligent audiovisual control system is provided that utilizes a hierarchical, agentic artificial-intelligence framework. A large language model (LLM) operating as a room agent interprets input data and delegates execution to one or more task-specific LLMs that perform specialized functions. The system establishes communication among agents and includes an environment-assignment module for binding agents to physical environments or functional domains, and defines supervisory and subordinate relationships across physical environments. Each agent monitors sensor data and actuates connected control systems such as lighting, HVAC, and audiovisual equipment. The architecture enables scalable, context-aware, and privacy-preserving coordination of intelligent environments through distributed reasoning and autonomous task delegation.

### PRIORITY

This application is a non-provisional of and claims priority to U.S. patent application Ser. No. 63/711,872, filed Oct. 25, 2024, entitled “SYSTEMS AND METHODS OF DEEP REINFORCEMENT LEARNING WITHIN AN AUDIOVISUAL ENVIRONMENT,” naming Allen et al. as inventors; U.S. patent application Ser. No. 63/711,848, filed Oct. 25, 2024, entitled “SYSTEMS AND METHODS OF AN AUDIOVISUAL ENVIRONMENT,” naming Josh Foster as inventor; U.S. patent application Ser. No. 63/752,202, filed on Jan. 31, 2025, entitled “SYSTEMS AND METHODS OF AN AUDIOVISUAL ENVIRONMENT INVOLVING ROOM READINESS, LOST OBJECT DETECTION, TOKENIZATION AND PRIVATIZATION,” naming Jaynes et al. as inventors; and U.S. patent application Ser. No. 63/818,847, filed Jun. 6, 2025, entitled “INTELLIGENT AUDIOVISUAL CONTROL SYSTEMS AND METHODS WITH LLM-BASED ROOM AGENT AND SPECIALIZED SUB-AGENT COORDINATION,” naming Jaynes et al. as inventors, the disclosures of which are all hereby incorporated by reference in their entirety.

### TECHNICAL FIELD

The present disclosure relates to an audiovisual system. In particular, the present disclosure relates to an audiovisual system accommodating one or more individuals within an environment.

### BACKGROUND

Audiovisual systems are typically configured to interconnect, operate, and manage audio systems, video systems, and/or control systems for a particular location, such as a conference room, a classroom, and/or a convention center. Audiovisual system devices may include, but not be limited to, video cameras, microphones (e.g., dynamic beamforming microphones and stationary microphones), speakers, displays and monitors, amplifiers, processing cores, and/or other devices.

### SUMMARY

The present disclosure provides an intelligent audiovisual (e.g., an audio, video, and control (AVC)) system and associated methods for managing and optimizing conferencing environments or other spaces. In some embodiments, the system comprises one or more computing devices, an AI accelerator, and audiovisual components such as cameras, microphones, and displays, all of which may be communicatively coupled to a cloud-computing environment or operate on-premises.

In various embodiments, the system performs tasks such as identifying room occupants using face detection and corporate directories, integrating attendance data with meeting records, capturing and distributing written content, detecting lost objects and associating them with likely owners, adjusting room configurations based on occupancy, and determining whether a space is sufficiently prepared for an upcoming meeting.

In yet other embodiments, the system adopts an agentic artificial intelligence architecture in which a front-facing large language model (LLM) receives user requests, interprets the underlying task, and delegates execution to one of several task-specific LLM agents. These include a room readiness agent, lost item agent, tokenization agent, optical character recognition (OCR) agent, resource optimization agent, occupant identity agent, and meeting scheduling agent. Each task-specific agent is configured to perform a specialized function by interfacing with audiovisual hardware and software modules described herein. The room agent supervises these interactions and logs task metadata for future learning and system optimization.

In further embodiments, the system implements a hierarchical multi-agent framework in which any of the LLM-based agents may operate as a supervisory or subordinate agent within a distributed intelligence structure. A dedicated environment and hierarchy (E & H) engine manages bidirectional communication among agents and includes an environment assignment module that binds agents to specific physical spaces—such as rooms, floors, or buildings—or to functional domains such as HVAC control, lighting, or energy optimization. A hierarchy module maintains supervisory relationships among agents, enabling higher-level agents to coordinate operations across multiple environments while lower-level agents perform localized sensing and control functions.

This hierarchical, agentic architecture allows the system to reason, learn, and act across multiple levels of abstraction—ranging from individual room management to building-wide optimization—while maintaining contextual awareness and privacy-preserving operation. The resulting framework provides improved scalability, adaptive automation, and cross-domain coordination for intelligent audiovisual and building-control environments.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a block diagram illustrating an overview of devices on which some embodiments of the present technology can operate.

FIG. 2 is a block diagram illustrating an overview of an environment in which some embodiments of the present technology can operate.

FIG. 3 is a block diagram illustrating an overview of an environment in which some embodiments of the present technology can operate.

FIG. 4 is a flow diagram illustrating an overview of an environment in which some embodiments of the present technology can operate.

FIG. 5 is a flowchart illustrating a method for generating a list of occupants within a room, according to embodiments of the present disclosure.

FIG. 6 is a flowchart illustrating a method for adjusting a room booking system, according to embodiments of the present disclosure.

FIG. 7 is a flowchart illustrating a method for providing written content to at least one individual, according to embodiments of the present disclosure.

FIG. 8 is a flowchart illustrating a method for adjusting settings and configurations of an audiovisual system, according to embodiments of the present disclosure.

FIG. 9 is a flowchart illustrating a method for detecting an object and an associated owner of the object, that may be used for loss prevention, according to embodiments of the present disclosure.

FIG. 10 is a flowchart illustrating a method for determining whether a space is sufficiently ready for an upcoming meeting, according to embodiments of the present disclosure.

FIG. 11 is a flowchart illustrating a method for acting based on obfuscated audio data or video data, according to embodiments of the present disclosure.

FIG. 12 is a block diagram illustrating an LLM-based task agent used in conjunction with the system of FIG. 3, in accordance with certain illustrative embodiments of the present disclosure.

FIG. 13 is a block diagram illustrating an embodiment of an intelligence system that coordinates hierarchical sets of agents, in accordance with the present disclosure.

FIG. 14 is a flow chart of a method for coordinating tasks within an environment using an agentic artificial intelligence system, according to certain illustrative embodiments of the present disclosure.

### DETAILED DESCRIPTION

Audiovisual systems play a pivotal role in facilitating communication and collaboration. Whether for business meetings, remote work, or personal interactions, audiovisual platforms enable real-time conversations across geographical boundaries. These tools allow participants to see and hear each other, share screens, and collaborate on documents. With features like chat, breakout rooms, and virtual backgrounds, videoconferencing has become an integral part of our daily lives, bridging gaps and fostering connections in an increasingly digital landscape. One example of audiovisual system is an audio, video, and control (AVC) system, for example, that is included in the Seervision and Q-SYS technologies from QSC, LLC, the Assignee of the present disclosure.

An audiovisual system can be configured to manage and control functionality of audio features, video features, and control features. For example, an audiovisual system can be configured for use with microphones, cameras, amplifiers, and/or controllers. The audiovisual system can also include a plurality of related features, such as acoustic echo cancellation, audio tone control and filtering, audio dynamic range control, audio/video mixing and routing, audio/video delay synchronization, Public Address paging, video object detection, verification and recognition, multi-media player and a streamer functionality, user control interfaces, scheduling, third-party control, voice-over-IP (VoIP) and Session Initiated Protocol (SIP) functionality, scripting platform functionality, audio and video bridging, public address functionality, other audio and/or video output functionality, etc.

In modern corporate environments, the integration of advanced technology to streamline operations and enhance productivity is paramount. One such integration involves using cameras to stream Real-Time Streaming Protocol (RTSP) feeds to a module capable of performing computer vision techniques (e.g., an image analysis application program interface (API), face detection API, and the like). By employing the image analysis API and faces API, organizations can unlock a plethora of functionalities, ranging from attendance management to room utilization optimization. Technical aspects of the present disclosure explore the implementation of this integration through various practical use cases.

In a corporate setting, maintaining accurate records of meeting attendance is crucial. By utilizing the faces API with the RTSP stream from network cameras, organizations can automatically detect and identify individuals in a conference room based on a directory storing their corporate profiles. The implementation involves configuring the network camera to stream live video via RTSP, using the faces API to detect faces in the video stream and match them against the corporate directory, and automatically generating an attendance list based on the recognized individuals to integrate with meeting records. This use case ensures that attendance is accurately recorded without manual intervention, saving time and reducing errors.

Another valuable application is the ability to detect who is present in a conference room and schedule an ad-hoc meeting if no meeting is currently scheduled. This involves continuously monitoring the RTSP stream for face detection using the faces API, cross-referencing detected faces with the corporate directory to identify individuals, integrating with the room-booking system to check for existing schedules, and automatically creating a meeting invite for the detected individuals if no meeting is scheduled. Additionally, if the room is booked or if there is an open space available, suggestions for local rooms with appropriate sizes can be made. Conversely, if a meeting room is booked but never used during the scheduled time, the space can be opened up for others. This functionality allows for efficient utilization of conference rooms and ensures that impromptu discussions are documented and tracked.

During meetings, whiteboards are often used to jot down important points, ideas, and decisions. Capturing this content and distributing it as part of the meeting summary can enhance clarity and follow-up actions. The implementation involves using the network camera to focus on the whiteboard during the meeting, applying the image analysis API to perform OCR on the whiteboard content, and extracting the recognized text to integrate it into the meeting summary, along with the attendance list from the faces API. Beyond OCR, the system can also perform image and video captioning, which is great for visually impaired individuals who use screen readers. This use case ensures that valuable information from whiteboard sessions is not lost and can be referenced in future discussions.

Efficient management of conference room resources can be achieved by detecting the presence of chairs and whether they are occupied. This involves using the image analysis API to detect objects such as chairs in the RTSP stream, determining if a chair is occupied by cross-referencing with face detection data from the faces API, and disabling automatic camera preset recall zones for unoccupied chairs to save resources and avoid unnecessary adjustments. This application enhances room management by ensuring that resources are effectively utilized and reducing unnecessary wear on equipment.

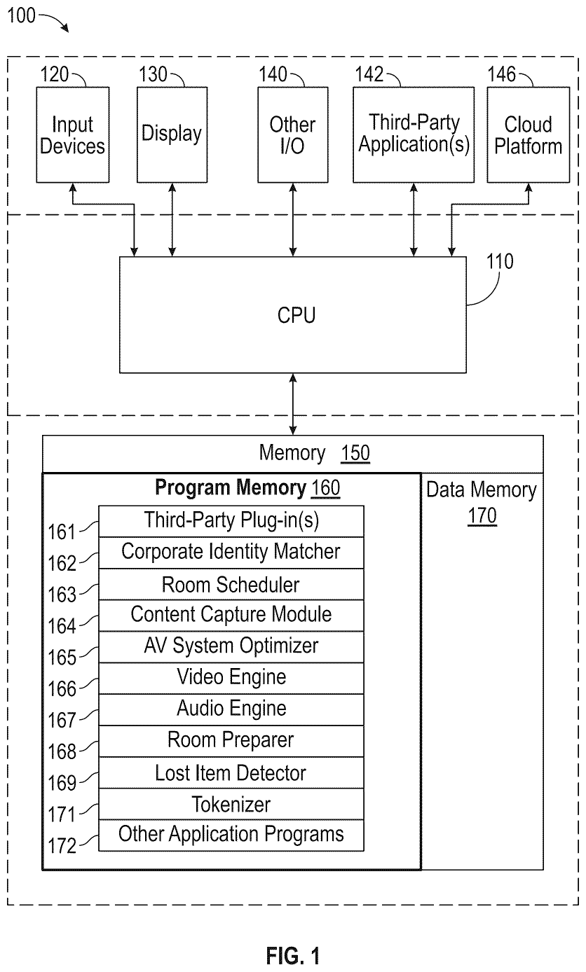

FIG. 1 is a block diagram illustrating an overview of an example of a device 100 on which embodiments of the present technology can operate. In the illustrated embodiment, device 100 includes one or more input devices 120 that provide input to one or more CPU(s) (processor, “the CPU”) 110, notifying it of actions. The actions can be mediated by a hardware controller that interprets the signals received from the input device and communicates the information to the CPU 110 using a communication protocol. Input devices 120 include, for example, a mouse, a keyboard, a touchscreen, an infrared sensor, a touchpad, a wearable input device, a camera- or image-based input device, a microphone, or other suitable user input devices.

The CPU 110 can be a single processing unit or multiple processing units in a device or distributed across multiple devices. CPU 110 can be coupled to other hardware devices, for example, with the use of a bus, such as a PCI bus or PCIe bus. The CPU 110 can communicate with a hardware controller for devices, such as for a display 130. The display 130 can be used to display text and graphics. In some embodiments, display 130 provides graphical and textual visual feedback to a user.

In some embodiments, the display 130 includes the input device as part of the display, such as when the input device is a touchscreen or is equipped with an eye direction monitoring system. In some embodiments, the display is separate from the input device. Examples of display devices include an LCD display screen, an LED display screen, an OLED display screen, an AMOLED display screen, a projected, holographic, or augmented reality display (such as a heads-up display device or a head-mounted device), codec (e.g., encoder, decoder, or both) for decoding IP signals received from other devices over an IP network or coding IP signals for transmission over an IP network, and so on. In embodiments, display 130 may receive content via a web browser; and, additionally/alternatively, a third-party application (e.g., third-party application 142) may run on an AI accelerator (not shown) and may be accessible by any computing device via a web browser. Other I/O devices 140 can also be coupled to the processor; I/O devices 140 may include a network card, video card, audio card, USB, firewire or other external device, camera, printer, speakers, CD-ROM drive, DVD drive, disk drive, Blu-Ray device, and the like.

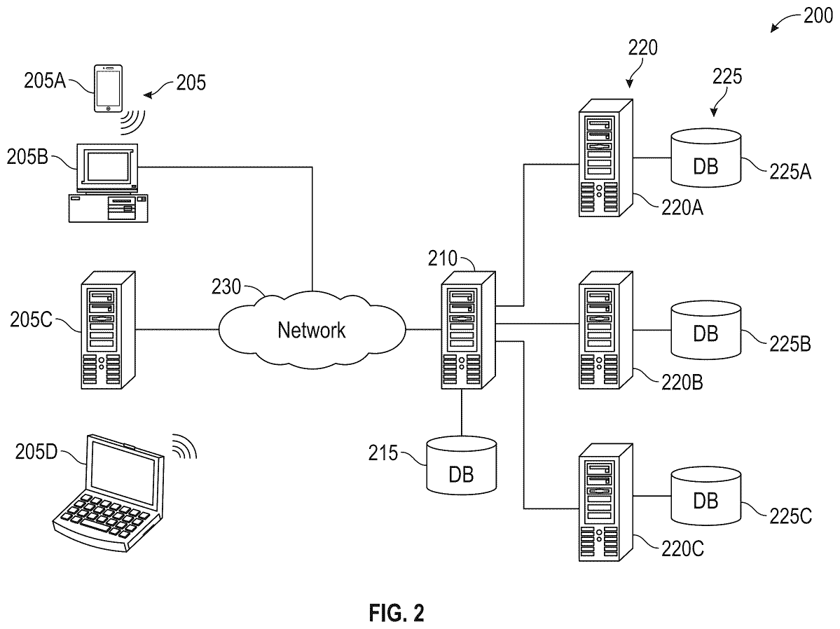

Device 100 further includes software and hardware components, such as third-party application 142 (e.g., Gmail, Outlook, Teams, and so on) and a cloud platform 146 (e.g., cloud platform 320), as described below with reference to FIGS. 2-4.

In some embodiments, device 100 also includes a communication device (not shown) capable of communicating wirelessly or wire-based with a network node. The communication device can communicate with another device or a server through a network using, for example, TCP/IP protocols, a Q-LAN protocol, or others. Device 100 can utilize the communication device to distribute operations across multiple network devices.

The CPU 110 can have access to a memory 150 in a device or distributed across multiple devices. Memory 150 includes one or more of various hardware devices for volatile and non-volatile storage and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 150 can include program memory 160 that stores programs and software, such as a third-party plug-in(s) 161, a corporate identity matcher 162, a room scheduler 163, a content capture module 164, an Audio-Video (AV) system optimizer 165, a video engine 166, an audio engine 167, a room preparer 168, a lost item detector 169, tokenizer 171, and other application programs 172. Memory 150 can also include data memory 170 that can store data to be operated on by applications, configuration data, settings, options or preferences, etc., which can be provided to the program memory 160 or any element of the device 100.

Some embodiments can be operational with numerous other computing system environments or configurations. Examples of computing systems, environments, and/or configurations that may be suitable for use with the technology include, but are not limited to, sets of personal computers, loudspeakers, AVC I/O systems, large-language models, semantic and syntactic analysis devices, computing devices configured to execute compute-intensive machine-learning models, networked AVC peripherals (e.g., IP camera(s), IP microphone(s), IP speaker(s), IP touch-screen controllers, and so on, as well as the same but not of an IP-based nature), server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2 is a block diagram illustrating an overview of an environment in which embodiments of the present technology can operate. Environment 200 can include one or more client computing devices 205A-D, examples of which can include the device 200 of FIG. 2. In the illustrated embodiment, device 205A is a wireless smartphone or tablet, device 205B is a desktop computer, device 205C is a computer system, and device 205D is a wireless laptop. These are only examples of some of the devices, and other embodiments can include other computing devices. For example, device 205C can be a server (e.g., AI accelerator, an LLM server, an LAM server, and so on) with an Operating System (OS) implementing compute-intensive machine-learning models. For example, device 205C can be a server running a large-language model. Additionally, or alternatively, client computing devices 205 can operate in a networked environment using logical connections through network 230 to one or more remote computers, such as a server computing device 210 to provide these services.

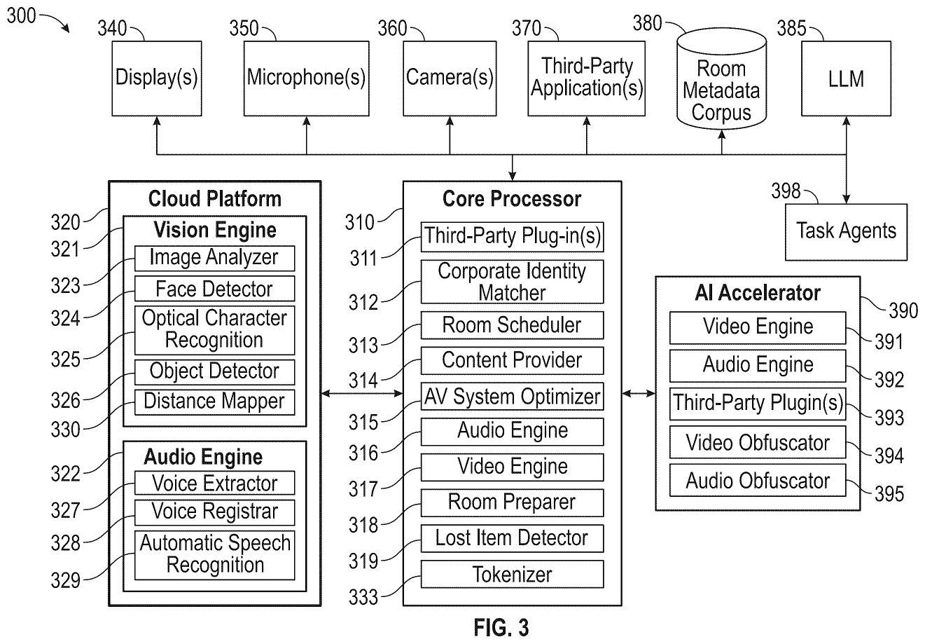

In some embodiments, the server computing device 210 is an edge server which receives client requests and coordinates the fulfillment of those requests through other servers, such as first-third server computing devices 220A-C (sometimes referred to collectively as “server computing devices 220”). Server computing devices 210 and 220 (or computing devices 205A-C) can comprise computing systems, such as the computing device discussed in more detail below with reference to FIG. 3 and/or the device 100 of FIG. 1. Though each server computing device 110 and 120 is displayed logically as a single server, server computing devices can each be a distributed computing environment encompassing multiple computing devices located at the same or at geographically disparate physical locations. In some embodiments, each of the server computing devices 120 corresponds to a group of servers.

Client computing devices 205 and server computing devices 210 and 220 can each function as a server or client to other server/client devices. The server computing device 210 can connect to a database 215. The first-third server computing devices 220A-C can each connect to a corresponding one of first-third databases 225A-C (sometimes referred to collectively as “databases 225”). As discussed above, each of the server computing devices 220 can correspond to a group of servers, and each of these servers can share a database or can have their own database. Databases 215 and 225 can warehouse (e.g., store) information. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN) but can also be other wired or wireless networks. In some embodiments, portions of network 230 can be a LAN or WAN implementing a relevant communication protocol. Portions of network 230 may be the Internet or some other public or private network. Client computing devices 205 can be connected to network 230 through a network interface, such as by wired or wireless communication. While the connections between server computing device 210 and the server computing devices 220 are shown as separate connections, these connections can be any kind of local, wide area, wired, or wireless network, including network 230 or a separate public or private network.

FIG. 3 is a block diagram illustrating an overview of an environment in which embodiments of the present technology can operate. The following components/devices/modules shown in FIG. 3 can be in any location (e.g., on-premises, a cloud platform, and so on). Environment 300 includes a core processor 310, a cloud platform 320, a display 340, at least one microphone 350, at least one camera 360, at least one third-party application 370, room metadata corpus 380, large language model (LLM) or large action model (LAM) 385 (hereinafter referred to as LLM 385), and an AI accelerator 390.

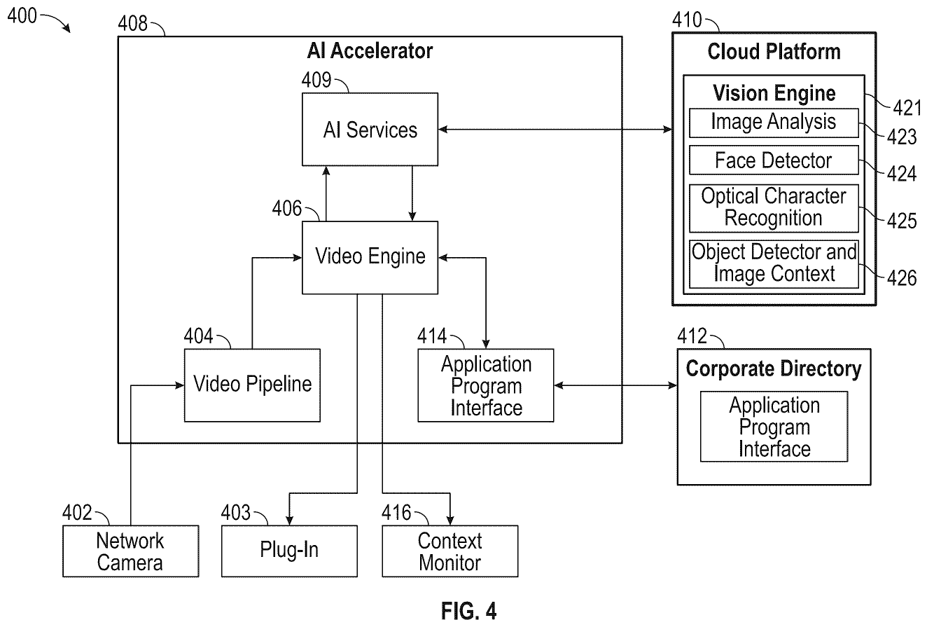

Core processor 310 can manage and process audio, video, and control signals from any of, for example, display 340, microphone 350, camera 360, and third-party application 370 in real-time. Core processor 310 includes third-party plugin(s) 311, a corporate identity matcher 312, a room scheduler 313, content provider 314, audiovisual (AV) system optimizer 315, audio engine 316, video engine 317, room preparer 318, lost item detector 319, tokenizer 333, and other application program(s) (not shown). In embodiments, third-party plugin 311 may include a calendaring or messaging plug-in (or any other type of third-party plugin-in, such as a corporate directory, as discussed below with reference to at least FIG. 4) may correspond to third-party application (e.g., third-party application 370) configuring the operating system running on core processor 310 to perform specific features or functions.

Corporate identity matcher 312 may receive a snapshot of a person's face (e.g., a thumbnail or any other type of image data representative of a person's facial characteristics) received from cloud platform 320, as discussed in more detail below. Further, corporate identity matcher 312 may reference a corporate directory (not shown in FIG. 3; e.g., corporate directory 412) or third-party plug-in 311 (e.g., a messaging or calendaring application, such as Teams or Outlook, respectively, that stores such information). In embodiments, third-party plug-in 311 may include employee information and an associated picture of the employee. Corporate identity matcher 312 may match any of the received snapshots with a corresponding picture of the employee to determine, for example, which employees are within a particular space.

Room scheduler 313 may be a software application configured to manage the booking and scheduling of rooms, conference rooms, or other spaces within an office building, event center, and the like. Room scheduler 313 may be an application configured to access, or integrate with, a calendaring or scheduling application (e.g., third-party plug-in 311) and determine which rooms within a building can accommodate scheduled appointments. Further, room scheduler 313 can optimize schedules and room usage efficiently, and allows users to visualize room availability to make reservations. Room scheduler 313 may include real-time room availability display, booking and reservation management, integration with room-occupancy sensors (e.g., microphone(s), camera(s) 360, and the like), and so on.

Content provider 314 may be a software application configured to receive content recognized by optical character recognition 325 (as discussed below) and provide that content to respective employees who, for example, are/were within a room where the content was captured or who may desire the captured content because, for example, of their job role. Content provider may determine who to provide the content to by receiving matches of people within the room from corporate identity matcher 312 or by referencing the corporate directory (not shown) or third-party plug-in 311 to determine job roles related to the content, e.g., based on a similarity between the content and the job description and/or level of seniority. For example, content provider may provide employees with a job title, Acoustic Engineer, captured content denoting equations relating to acoustical characteristics that were written on a whiteboard, and the like. Content provider 314 may transmit content to any employee via one or more applications (e.g., messaging such as Teams or Slack, text message, email, and the like).

Audiovisual system optimizer 315 may be a software application configured to enhance the performance of one or more of the following components: core processor 310, display 340, microphone 350, camera 360, AI accelerator 390, and so on. For example, AV system optimizer 315 may perform automatic calibration: adjust audio levels, equalization, and video settings, (e.g., brightness, contrast, color balance, and the like), to optimize acoustics (e.g., process room acoustics and adjust sound settings to eliminate echo, reverb, or distortion) and visuals within environment 300. Further, AV system optimizer 315 may perform signal routing optimization: facilitating efficient signal transmission and reception between any of components within environment 300, minimizing latency, and the like. Further, AV system optimizer 315 may manage audiovisual synchronization, for example, by managing and syncing audio and video streams for alignment, eliminating latency between audio and video signals.

Audiovisual system optimizer 315 may receive video, image, or audio data from camera 360 or microphone 350, respectively. In addition to, or alternatively, AV system optimizer 315 may receive room-occupancy data from image analyzer 323 that indicates which chairs within a room are empty by, for example, image analyzer 323 analyzing data obtained by one or both of face detector 324 and object detector 326. AV system optimizer 315 may determine which zone the empty chair resides within and instruct one of camera(s) 360 not to capture video or image data of that zone. For example, automatic camera preset recall refers to a feature found in audiovisual systems that allows a camera to automatically return to a pre-defined position, zoom level, focus setting, etc., each of which may be set to cover a particular zone within, for example, a conference room. The predefined settings can be programmed in advance, and the camera can recall them based on certain triggers, such as a specific event or a command from a program or user.

Audio engine 316 may comprise a specialized software or hardware component designed to automatically process, analyze, and manage audio captured by microphone 350 and is received by core processor 310. Audio engine 316 may perform various tasks on the captured audio data such as speech recognition, sound classification, blind-source separation (e.g., separating audio signals of different talkers, separating audio signals of noise from audio signals of talkers, and so on), voice activity detection, audio event detection and classification, and so on.

Video engine 317 may comprise a specialized software or hardware component designed to automatically process, analyze, and manage video data captured by camera 360 and received by core processor 310. Video engine 317 may perform various AI tasks, such as real-time video analysis, object detection, object recognition and classification, object grouping, object framing, motion tracking, and content recognition. Room preparer 318 may comprise a specialized software or hardware component designed to automatically process and analyze meeting information and audio and video data to prepare a meeting room accordingly. Further, room preparer may facilitate room readiness by passing along meeting information and audio and video data to LLM 385 so that LLM 385 can determine a state of a space—whether there is an ongoing meeting or the room is empty—to assist in meeting-room preparedness, including whether the room is ready for a scheduled meeting and what specific issues require attention before the meeting can occur, as discussed below.

Lost item detector 319 may comprise specialized hardware and software designed to associate objects within an image/video frame captured by camera 360 and processed by video engine 317 and vision engine 321, as discussed below, with respective owners. Further, lost item detector 319 may act upon an object being left behind within a space (e.g., conference room). For example, lost item detector 319 may alert (e.g., send the owner an email, text message, message, call, etc.) the owner of the object by receiving owner information from corporate identify matcher 312; alert facilities management; transmit a message to room preparer 318 that the space is no longer ready for a scheduled meeting; and the like.

Tokenizer 333 may comprise a specialized software or hardware component designed to automatically process obscured audio and video data from either or both video obfuscator 331 and audio obfuscator 332. Tokenizer 333 may provide the obfuscated video and audio data, that video obfuscator 331 and audio obfuscator 332, respectively, have obfuscated (tokenized) to remove confidential, private, personal, sensitive, and similar kinds of information, to LLM 385. As discussed below, video obfuscator 331 and audio obfuscator 332 will obfuscate (or lorem ipsum: cover the confidential or sensitive information with placeholder information) the video data and audio data, respectively, while retaining the training signal such that LLM 385 does not ingest the confidential or sensitive information but can still conduct actions based on commands discerned from LLM 385 processing the audio and video data.

Cloud platform 320 includes a vision engine 321 and an audio engine 322. Vision engine includes an image analyzer 323, a face detector 324, an optical character recognizer 325, and an object detector 326. Audio engine 322 includes a voice extractor 327, a voice registrar 328, and automatic speech recognition 329. Image analyzer 323 may be a software application configured to process and examine visual data from video or image data using techniques to extract meaningful information. Image analyzer 323 may perform pattern detection, color and texture analysis, image segmentation, feature extraction, image or object classification, and the like.

Face detector 324 may be a software application or algorithm designed to locate and identify human faces within image or video data (frames). Face detector 324 may perform any of the following methods or techniques: Haar cascade classifiers, histogram of oriented gradients, deep learning-based detectors (e.g., methods that rely on deep learning models, such as convolutional neural networks), and the like. Optical character recognition 325 is a software application capable of converting different types of documents or image and video data (frames), for example captured by camera 360, into machine-readable and editable texts.

Object detector 326 is a software application capable of locating and identifying objects within image data or video data, for example captured by camera 360. Object detector 326 may identify specific objects and their corresponding location by placing bounding boxes around them and labeling them. Object detector 326 may employ such algorithms as you only look once (YOLO), single shot multibox detector (SSD), region-based convolutional neural network (faster R-CNN), MobileNet-SSD, and so on.

Distance mapper 330 may comprise specialized hardware or software designed to determine a distance, in two-dimensional and/or three-dimensional space, between any of two or more objects located and identified by object detector 326. For example, in two-dimensional space, distance mapper may receive image/video frame(s) captured by camera(s) 360 (e.g., by a single camera from a single angle, single camera from multiple angles, by multiple cameras from different angles, and so on) and processed by any one of video engine 317 of core processor 310, object detector 326 of cloud platform 320, or video engine 391 of AI accelerator, and map the identified objects within the image/video frame to a two-dimensional coordinate space (e.g., an x, y-axis). Distance mapper 330 may determine the distance between any of the two or more identified objects within the two-dimensional coordinate space by using any mathematical techniques commonly known in the art. For example, within the image/video frame, a first pixel denoting a center of mass for the first object may be designated as a center point for the first object and a second pixel denoting the center of mass for the second object may be designated as a center of mass for the second object. From this, the x and y-coordinates for each of the first and second center points may be used to determine distance from the first object and the second object by using, for example, the “distance formula”: d=√((x2 −x1)²+(y2−y1)²).

Distance mapper 330 may determine a distance between the two objects in three-dimensional space by, for example, employing monocular depth estimation. Monocular depth estimation may designate each pixel within the image/video frame a numerical value between 0 and 1 to denote the distance from the camera (e.g., camera(s) 360) capturing the video data. Using the method above, distance mapper 330 may determine a pixel representing a center of mass for each object calculate the distance from each pixel designating respective center of masses to determine the distance between each object while considering the depth of each pixel between each object. In embodiments, the distance between each object may be determined in other ways, for example, by designating any pixel of an object for use in determining a distance to another object. In embodiments, any mathematical techniques or machine learning models may be used to determine the distance between any points of the two objects.

Distance mapper 330 may send lost item detector 319 the distances determined by distance mapper 330 between each of the objects for lost item detector to determine which object may be an owner and which object may be associated with an owner, as discussed above and throughout the disclosure. Further, distance mapper 330 may continuously receive images, for example, from object detector 326 and thus continuously track the distance between objects throughout a meeting. In embodiments, distance mapper 330 may send lost item detector respective distances between objects once every certain amount of time, for example, once every ten seconds, thirty seconds, minute, five minutes, and so on.

In embodiments, rather than distance mapper 330 determining a distance between objects, lost item detector 319 may send video data and audio data to LLM 385 for LLM 385 to determine which objects are associated with a particular owner.

Voice extractor 327 of audio engine 322 may comprise a software application capable of isolating (or separating, for example, when audio engine 316 may not have employed blind source separation, etc.) voice from audio data that includes other noise, such as multiple speakers, background noise, etc. Voice extractor 327 may employ at least one of the following algorithms, including source separation, spectral subtraction, machine learning, artificial intelligence, time-frequency masking, etc. Voice registrar 328 may comprise a software application that manages, records, and so on, the voice data extracted by voice extractor 327, e.g., and assign voice data to a particular employee within corporate identity. Voice registrar 328 may perform voice recording, logging and timestamping, archiving and retrieval, transcription (e.g., for feeding to an LLM module, such as LLM 385, as discussed throughout), and the like. Automatic speech recognition 329 comprises a software application designed to convert spoken language to text, for example, for video captioning. Automatic speech recognition 329 may employ such algorithms as hidden Markov models, deep neural networks, end-to-end models, etc.

AI accelerator 390 may comprise a specialized hardware component or system designed to increase the efficacy of computational processes required for artificial-intelligence tasks, particularly those relating to machine learning or deep-reinforcement learning. For example, AI accelerator 390 may comprise any of graphics processing units to ingest and process video data, tensor processing units for processing deep-learning tasks and large-scale neural network computations for processing audio data, field-programmable gate arrays, application-specific integrated circuits to accelerate neural network operations, and neural processing units dedicated to processing image and video data and natural language processing. Artificial intelligence tasks (such as neural networks and the like) require complex calculations that are computationally intensive. AI accelerator 390 may be able to manage these types of tasks more efficiently than core processor 310.

Video engine 391, audio engine 392, and third-party plug-in 393 may be substantially similar to audio engine 316 (or audio engine), video engine 317 (or audio engine), and third-party plug-in 311, respectively; however, the components within AI accelerator 390 may leverage the specialized hardware and computational processes of AI accelerator 390, and may be located on-prem for quicker response times. Further, AI accelerator 390 may be privately owned, whereas cloud platform 320 may be owned by a third-party.

In embodiments, actions performed by audio engine 316 (or any component 322-329 of audio engine 322) or video engine 317 (or any component 323-330 of vision engine 321) may be performed by audio engine 392 or video engine 391, respectively. In embodiments, actions that require more processing power or complex calculations that are computationally intensive that are available to audio engine 392 or video engine 391, but unavailable to audio engine 316 or video engine 317, respectively, may be performed by audio engine 392 or video engine 391.

Video obfuscator 394 may be specialized software or hardware designed to transform video data into a form that masks or obfuscates sensitive or confidential information while preserving the underlying structure and key features relevant for LLM 385 to perform task(s). As an example, a frame of video data captured by camera(s) 360 may include participants within a conference room writing attorney work product on a whiteboard, in a notebook, or having such visible on a word document displaying on a personal device. Video obfuscator 394 may use a pre-trained convolutional neural network to extract feature embeddings from the image. For example, video obfuscator 331 may transform faces of participants into a set of numerical vectors (e.g., eigenvectors, etc.) representing facial features but without reconstructing visual details. For the attorney work product written on the whiteboard or on the laptop display, video obfuscator 394 may apply techniques commonly known in the art, such as pixelation, Gaussian blurring, masking, and so on to remove sensitive or confidential details while retaining the general structure.

In embodiments, video obfuscator 394 may perform encryption-like transformations, such as homomorphic encryption or secure multi-party computation to transform the image or frame of video data into an encrypted or pseudonymized format while still allowing for LLM 385 or another module to perform computations. In embodiments, video obfuscator 394 may use vector quantization, for example, quantizing the image into a lower-dimensional space where sensitive information is lost while structural patterns remain. For example, video obfuscator 394 may compress the image into non-invertible tokens for use in particular machine learning models that are commonly known in the art. As another example, video obfuscator 394 may tokenize the data into symbolic representations that maintain semantic meaning but hide original content.

Audio obfuscator 395 may comprise specialized hardware or software designed to transform audio data into a form that masks or obfuscates sensitive or confidential information while preserving the underlying structure and key features relevant for LLM 385 to perform task(s). For example, audio obfuscator 395 may perform any of the following methods: employing pitch shifting or voice distortion (e.g., alter pitch, speed, or tone to anonymize the identify of a speaker while preserving intelligibility) and noise injection or filtering (e.g., adding background noise or removing specific frequencies to obscure the confidential or sensitive information). As yet another example, audio obfuscator 395 may process the audio data to obfuscate or transform spectral features (e.g., numerical representations of the frequency content of a particular audio signal, derived by analyzing its spectrum). Spectral features may include capturing salient characteristics of sound, such as pitch, timbre, and energy, while discarding details such as waveform data, that might contain confidential or sensitive (e.g., identifying, etc.) information.

Further, audio obfuscator 395 may transcribe all audio data and remove or convert sensitive or confidential information while preserving the remaining information in the transcription such that LLM 385 can perform a task. Audio obfuscator 395 may additionally provide relevant context when removing or converting sensitive or confidential information omits necessary context. For example, the name or title of the speaker may be removed, however, a designation of seniority or employee importance (e.g., CEO, general counsel, etc.) may be concatenated to the transcription so LLM 385 is aware the employee may have final authority or there is potentially attorney-client privilege or work product attached to the conversation.

In embodiments, video obfuscator 394 and audio obfuscator 395 may tailor the obfuscation of video data and audio data, respectively, towards an intended use by LLM 385.

In one non-limiting example, core processor 310 may receive audio and/or video data captured from microphone 350 or camera 360. In embodiments, camera 360 may be configured to stream video data via real-time streaming protocol. Core processor 310 may send captured audio and video data to audio engine 323 and video engine 322, respectively, for processing. Video engine 322 may process the video data so that the video data is correctly formatted for processing by any component 323-326 of vision engine 321.

Audio engine 316 may process the audio data so that the audio data is correctly formatted for processing by audio engine 322. Audio engine 316 may include one or more machine learning models, such as blind source separation, and the like, that can separate speech from noise so that the speech can be clearly identified within the captured audio data. In embodiments, when a participant speaks, along with vision engine 321 detecting the face of the employee and corporate identity matcher 312 associating the detected face with an employee profile, voice extractor 327 may isolate the particular matched employee's acoustic signature when the employee speaks and voice registrar 328 may store that acoustic signature along with employee information within a database (not shown).

Core processor 310 may send the video and audio data to cloud platform 320 for processing by vision engine 321 and audio engine 322, respectively. In embodiments, face detector 324 may detect one or more faces within one or more frames of received video data. Image analysis 323 may create snapshots or thumbnails of each of the one or more detected faces within frames of the video data. Cloud platform 320 may send the created snapshots or thumbnails to corporate identity matcher 312. Corporate identity matcher 312 may reference third-party plug-in 311 (e.g., a corporate directory including image data representing each employee of a, for example, corporation) to determine whether any of the received snapshots of thumbnails match image data representing an employee within corporate directory. Corporate identity matcher 312 may generate a list of each of the matched employees and integrate the list, for example, with meeting records (e.g., generated by third-party plug-in 311, such as Teams, Zoom, and the like).

Technical aspects of the present disclosure address the problem of when individuals enter an empty room and conduct an ad-hoc meeting, creating a problem in a room-booking system. Technical aspects of the present disclosure provide a solution to the problem by reflecting the ad-hoc meeting within the room-booking system. In addition, or alternatively, to corporate identity matcher 312 integrating the list with meeting record, the list may be integrated with a room-booking system. For example, room scheduler 313 may receive the list from corporate identity matcher 312 or reference the corporate directory to determine whether any of the received snapshots of thumbnails match image data representing an employee within corporate directory. Further, room scheduler 313 may generate a substantially similar list (as described above) of each of the matched employees and integrate this list with the room booking system (e.g., third-party plug-in 311) so that the room-booking system is updated to reflect the ad-hoc meeting. In embodiments, when there is not a meeting scheduled for the empty room at the time, room scheduler may schedule an ad-hoc meeting for the matched employees and update the room booking system with the employees within the room, the room, and the date/time.

In embodiments, when a room is booked, or if there is an open space available, room scheduler 313 can make suggestions for local rooms, with appropriate size etc., for the occupants based on referencing the room booking system. In embodiments, if a meeting room is booked, but never used during the time, room scheduler 313 can adjust the room booking system so that the regular vacancy is reflected within the room-booking system. Further, metadata regarding findings, adjustments to room-booking system, squatter meetings, zombie meetings, and the like may be stored within room metadata corpus 380 for analysis to determine trends and such of scheduling, room-booking system, and so on. For example, any component 311-317 of core processer 310 may reference room metadata corpus 380 for improving performance and carrying out tasks. This functionality allows for efficient utilization of conference rooms and ensures that impromptu discussions are documented and tracked.

During a meeting, a whiteboard is often used to write important points, ideas, and decisions. Capturing this content and distributing the content as part of the meeting records (as discussed above) can enhance clarity and follow-up actions taken by employees. Technical aspects of the present disclosure provide a method and system for capturing content, characterizing the content, and providing the content to one or more employees, for example, based on a generated list of matched employees, as discussed above, ensuring valuable information from whiteboard sessions is not lost and can be referenced in future discussions.

In embodiments, as discussed above, vision engine 321 may receive video data and audio data from core processor 310. In this embodiment, camera 360 may be directed at a white board (not shown) to capture any written content. Optical character recognizer 325 may perform optical character recognition on the individual frames of video data that includes captured content. For example, optical character recognition 325 may convert the individual frames of the video data into editable and searchable text. In embodiments, the editable and searchable text may be sent to an LLM module 385 for generating a summary of the content, checking for factual inaccuracies, proposing additional ideas that are conducive with the scope and purpose of the content, references that discuss the content such as research articles, and the like.

Content provider 314 may receive from cloud platform 320 the editable and searchable text and any content generated by LLM 385 to supplement the text. Content provider 314 may integrate the editable and searchable text and LLM-generated content into the meeting records along with the generated list of matched employees, as discussed above. Content provider 314 may leverage the generated list of matched employees to determine who attended the meeting and further who to send the editable and searchable text and LLM-generated content. Content provider 314 may send the editable and searchable text and LLM-generated content via third-party plug-in (e.g., messaging application, email, and so on).

In embodiments, LLM 385 may be a large action model (LAM) and may generate content based on the editable and searchable text to provide context for the visually or aurally impaired. For example, in addition to optical character recognition 325 generating the editable and searchable text for LLM 385 to generate content, automatic speech recognition 328 may receive audio data from audio engine 316 and convert spoken language (e.g., post BSS processing to separate the speech from non-speech noise) into text that is sent to LLM 385 for content generation. In embodiments, LLM 385 may not receive text from either optical character recognition 325 or automatic speech recognition 328; rather, either of optical character recognition 325 or automatic speech recognition 328 may send text directly to content provider 314 destined for sending over a network for video captioning and audio captioning (e.g., a screen reader).

One concern in the technical field of audiovisual conferencing: when using large language models in the cloud, there is the potential for sensitive, personal, or confidential data being sent to a public, third-party cloud platform rather than being processed under control of a private owner, for example, on-premises.

By combining local (e.g., at the edge, such as with AI accelerator 390) AI models that may be significantly smaller than those that may be running on cloud platforms, technical aspects of the present disclosure can preprocess the image data, audio data, or other data prior to sending to the cloud platform in such a way as to obfuscate sensitive information while keeping the semantics or structure of the image, audio, or other data intact.

Modern cameras have incredible sensor resolution coupled with excellent optical paths. While designed to give excellent visual performance to the end user, a side effect of the rich image quality is the ability to recognize text in an image. This text no longer has to be large or written on a specific whiteboard for the content to be easily recognizable. Text can be recognized on notebooks, computers, shirts, whiteboards, even food or product labeling-all from afar. Because notes taken during meetings-either on paper, computer, or whiteboard are often confidential-it is important to some that this data never leaves the premises.

Technical aspects of the present disclosure provide a method addressing this concern in the following way. Using a whiteboard as an example, one solution to the problem would be to use an on-premises vision algorithm (e.g., video engine 391) to determine the location and extent of a whiteboard in the room. Then, prior to sending an image of the room to a cloud-based LAM (large action models, such as LLM 385, that may be a large language model and/or a large action model) for contextual analysis, local processing by video obfuscator 394 can replace the content of the whiteboard with a background flood that eliminates all text and “erases” (aka blanked out) the whiteboard. Similarly, video obfuscator 394 can remove the entire extent of the whiteboard from the image.

Although video obfuscator 394 removing content from images may be effective in preventing the shipment of sensitive information to a cloud-platform (e.g., cloud platform 320, LLM 385, etc.), the above solution removes valuable information about the context or state of the room. Therefore, technical advantages of the present disclosure also provide for the following method to address the problem. Using the same example of a whiteboard, the on-premises vision algorithms (e.g., digital signal processing, artificial intelligence, or other methods performed by video engine 391) would recognize the locations and length of the markings and replace the markings in the image with either ‘fuzzy’ text (aka fogging) or replacing the text with some sort of aspect corrected ‘boilerplate’ that is either gibberish or an instructive message like “The text in this area has been obfuscated per privacy rules”. These solutions are preferred because from the perspective of the LAM, the whiteboard has content on it, and if the requirement to determine the ready state of a meeting room is in part based on the cleanliness of the whiteboard, so long as the whiteboard has content, the LAM will see the board as ‘dirty’, as discussed throughout with respect to room-readiness, room preparer 318. Imagery in the form of flipcharts, power point slides, and graphics on a whiteboard are also common artifacts of meeting recording and capture. As with text, these data need to be similarly obfuscated prior to uploading to the cloud platform (e.g., cloud platform 320, LLM, etc.).

Technical aspects of the present disclosure provide an alternative solution that hybridizes the above. An on-premises vision algorithm (e.g., video engine 391 or video obfuscator 394) determines the location of the whiteboard, detects if there are markings or text on it, sets a metadata flag to reflect the binary presence of markings/text (i.e., true/false), then blanks or blocks out the whiteboard before sending the image to the LAM in the cloud.

It should be noted that the solutions above are simply designed to obfuscate text prior to sending an image to the public or remote cloud platform. The solutions above are not limited to a whiteboard and can be extended to cover all forms of text visible in the space, such as text displayed on laptops, displays, and so on.

Similarly, the local vision processing does not have to be solely used to detect and obfuscate text. There exists solutions spaces where the text needs to be captured and analyzed locally for notes capture (optical character recognition→augmented transcription) AND the room image be sent to the cloud. The two local tasks (obfuscation and OCR) can be performed in parallel, or by a single serial process beginning with OCR.

Understanding how many people are in a space along with their locations, and other information is also very important semantic information—yet can also be considered private, sensitive, or confidential information. Following the flow of the text solution above, feature recognizable human elements can be fogged or blanked out at the edge, prior to image shipment to a cloud platform (e.g., cloud platform 320, LLM 385, etc.). Feature recognizable elements could be as simple as fogging the face of the human to as complex as removing or fogging their entire form and replacing with locally generated metadata about the desirable data.

At times, a meeting room may not be prepared accordingly for an upcoming meeting. For example, there may be too many chairs surrounding a table or the shades may not be drawn correctly to prevent glare within the room. According to technical aspects of the present disclosure, room preparer 318 may prepare a room in anticipation of a meeting. For example, prior to a meeting, room preparer 318 may reference room scheduler 313 and corporate directory (as discussed throughout) to identify which employees (and their title) will attend a particular meeting and any surrounding context relevant to the meeting, such as notes, power point slides, if the meeting regularly occurs (e.g., weekly, monthly, quarterly, meetings, and so on), and the like, the nature or importance of the meeting, such as an executive meeting, board of directors meeting, casual discussion, legal meeting, and so on included in a meeting invitation.

Room preparer 318 may determine from which employees are attending the meeting (e.g., CEO, General Counsel, CTO, etc.), the topic/title of the meeting, and the nature of the meeting, that the meeting should not be recorded nor there be a transcription. Room preparer 318 may instruct third-party plug-in (e.g., Teams, Zoom, etc.) to not record or transcribe the meeting and/or to disable this feature. Further, the room preparer 318 can reference the meeting notes/slides to determine if any supplemental context (e.g., additional information, such as from past meetings, or simple accuracy confirmation of the notes/slides) is appropriate.

In embodiments, room preparer 318 may further be capable of comparing audio and video data processed by any of audio engines 316, 392 or video engines 317, 391 and/or audio engine 322 or vision engine 321 against information comprised by corporate directory, room scheduler 313, or other components 312, 314, and 315 to prepare a meeting room. For example, room preparer 318 may receive processed video data from object detector 326 and determine that there are a certain number of chairs that, when referenced against the number of employees attending the meeting provided by room scheduler 313, the number of chairs exceed the number of employees. Room preparer 318 may generate and then send an alert to office staff (facilities management) to remove the excess chairs, or to bring in additional chairs when there are not enough.

Further, in addition to, or alternatively, room preparer 318 can receive video data captured from camera(s) 360 and feed the received video data to LLM 385, that may be trained to identify a state of a space during or not during an event to determine whether the space is ready for an upcoming meeting. For example, LLM 385 may be trained based a specific criteria to identify a desired state of a room that is ready for a meeting based on exemplary images of rooms fit for a particular meeting and based on several factors. For example, the training may comprise LLM 385 being able to discern clean from dirty or messy, such as whether the table is cluttered or near empty, whether there is trash on the floor, a whiteboard is clean, and so on, and score an image of a room based on the cleanliness of the room with a numerical value, for example, from zero to ten. For example, LLM 385 may score a five for an image of a room that includes the following: papers on the table, but no trash on the floor, and a cleaned whiteboard.

For when a meeting is ongoing, LLM 385 may also be trained on audio data captured by microphone(s) 350 to identify specific cues indicating that a room will not be ready in time for a following meeting. For example, LLM 385 may be trained to determine, based on audio data and specific cues, a room will not be ready in time because LLM 385 may receive attachments stored within calendaring application 370 that includes a slide deck with 40 slides, display 340 is presenting slide 30, and there are five minutes remaining in the meeting. LLM 385 may compare the attached slide deck within the calendaring application, received by room preparer 318, to video data captured by camera 360 capturing the presentation within a live feed or some other means. In embodiments, LLM 385 may discern from captured video data that the room will not be ready in time because participants are in deep collaboration, brainstorming on a whiteboard, and so on. Further, LLM 385 may compare received audio data to determine noises within the room (e.g., HVAC, from outside because a window is open, and so on) require attention, and notify facilities management of such.

Further, LLM 385 may be trained based on the specific criteria using, among others, the above factors to score whether the room is ready for a particular meeting, such as whether there are a sufficient number of chairs; the room is clean enough for the particular participants and based on the type of meeting (e.g., the difference between a board of directors meeting that will be recorded and a quick discussion about a coding problem); participants will not end the meeting on time; and so on. LLM 385 may determine the type of meeting from room preparer 318 facilitating meeting information (e.g., title of meeting, participants, meeting description and any attachments, location of meeting, and so on) by receiving such from a calendaring application and providing such to LLM 385. Further, LLM 385 may reference historical multi-modal data (e.g., comments from meeting participants regarding the cleanliness or messiness of the room to determine whether a room is sufficiently clean). The above criteria for training LLM 385 is a non-exhaustive list and may comprise any factor and score thereof for determining whether a room is sufficiently clean.

In embodiments, LLM 385 may determine whether the score satisfies a room-readiness threshold based in part on the above criteria. For example, each factor included in the criteria may have a respective score based on the image fed to LLM 385, as discussed above, that is then compared to a threshold score for whether the room is ready for a meeting. For example, the cleanliness factor of the above criteria may have a room-readiness threshold of eight; the factor regarding whether the room is fit for a particular type of meeting (e.g., correct number of chairs and the like) may have a room-readiness threshold of nine; and so on. LLM 385 may compare generated scores based on analyzing the image regarding each of the above factors to determine whether the room-readiness threshold has been satisfied.

If the room-readiness threshold has not been satisfied, LLM 385 identifies the issues (trash on table or floor, writings on whiteboard, etc.) and reports the issues to room preparer 318 so that room preparer 318 can task appropriate personnel, such as facilities or custodial staff, to address the problems. For example, upon room preparer 318 receiving the reported issues from LLM 385, room preparer 318 may reference room scheduler 313 to determine whether there is a clean room available for the particular type of meeting so that, if there is insufficient time for staff to clean the room, the location of the meeting can be changed to the clean room. As another example, room preparer 318 may send the report to facilities management so that staff can prepare the room before the meeting. When LLM 385 infers the state (e.g., opening remarks, presentation, deep collaboration) of an ongoing meeting will not end on time, room preparer 318 may notify room scheduler 313 to extend the meeting duration or reroute other meetings scheduled for the same location as the ongoing meeting to avoid interruptions.

Room preparer 318 may further reference historical statements (e.g., preferences, etc.) made by one or more of employees attending the meeting and may facilitate with AV system optimizer 315 that the preferences are executed. For example, an employee of a previous employee may have stated their preference of temperature being 70 degrees inside the room. In this example, room preparer 318 may reference that preference made in a statement and instruct smart thermometer to adjust the room temperature to the preferred temperature. When there are competing preferences made in historical statements that room preparer 318 is drawing from, the job title (e.g., CEO, General Counsel, etc.) may decide which preference is acted upon.

Further, room preparer 318 may reference a smart thermometer of a smart HVAC system via third-party plug-in 311 to determine a temperature of a meeting room and compare against a preferred temperature (e.g. what is considered room temperature or against statements previously made by employees attending the meeting). If the temperature does not satisfy a preferred temperature (e.g., the room's temperature is 55 degrees and the preferred temperature is 72 degrees), room preparer 318 may transmit an instruction, delivered via core processor 310, to the smart thermometer to increase the room temperature to the preferred temperature 72 degrees.

In embodiments, room preparer may reference AV system optimizer 315 for a system check (check the functionality of each audiovisual component) to determine whether each of the audiovisual components are working sufficiently for the upcoming meeting.

In addition, or alternatively, to the above, technical aspects provide systems and methods for efficient management of conference room resources by detecting the presence of chairs and whether they are occupied, as well as detecting objects left behind after meetings and notifying owners thereof. In embodiments, along with face detector 324 detecting faces within the individual frames of video data, object detector 326 may detect one or more objects within the individual frames of video data. Further, distance mapper 330, as discussed above, may receive the detected individuals from face detector 324 and detected objects from object detector 326 and determine a distance between each of the detected faces (or any point of the body of the face) and each object within the room. From this, either using two-dimensional mapping or, additionally, monocular depth estimation, distance mapper 330 may calculate and then assign a confidence score based on the determined distances between each of the objects and individuals. For example, the confidence scores may indicate a most likely individual that owns a particular object within the space. In embodiments, distance mapper 330 may use statistical or artificial intelligence techniques commonly known in the arts to calculate the confidence scores.

Distance mapper may send the confidence scores and the most likely owner of particular objects (e.g., in a table or the like) to lost item detector. When an individual has left an object behind within the space, lost item detector 319 may then reference corporate identity matcher 312 to determine information of the owner, for example, a cell phone number, email, and the like, so that lost item detector 319 may the notify the individual that the object has been left behind. Further, lost item detector may notify room scheduler, for example, in the case of the item being sensitive or confidential material, such as attorney work product, financial information, and so on, so that the following scheduled meeting is rescheduled for another room or until the sensitive or confidential information has been placed with the owner or securely removed. In embodiments, lost item detector 319 may notify room preparer 318 that the item has been left behind so that the room is cleared by someone from, for example, facilities management.

In embodiments, rather than distance mapper 330 determining distances between objects, lost item detector 319 may receive video data captured by camera 360 and, for example, processed by video engine 317. Lost item detector 319 may, at regular intervals (e.g., every 10 seconds, minute, 5 minutes, etc.) feed individual frames of the video data to a large language model (LLM) (e.g., LLM 385) that has been trained to identify an object and the most-likely, respective owner. In embodiments, lost item detector 319 may feed video data, or frames thereof, that object detector 326 of vision engine 321 has processed and has placed bounding boxes around one or more of the objects within frames of the video data.

According to technical aspects of the present disclosure, image analyzer 323 may receive data denoting the one or more detected faces and the one or more objects from face detector 324 and object detector 326, respectively. Image analyzer 323 may determine whether there is a person sitting in a chair or if the chair is empty, match objects to their respective owners, and the like. Image analysis 326 may send the determinations to, for example, AV system optimizer 315 so AV system optimizer can perform actions based on the determinations such as adjust the settings and configurations of one or more of core processor 310, display 340, microphone 350, camera 360, and AI accelerator 390, as discussed above. For example, when someone leaves behind an object, such as a laptop, phone, backpack, etc., that person may be contacted by, for example, content provider 314. For example, content provider 314 may receive the detected face and object, reference the corporate directory, as discussed above, to determine a potential owner of the object and communicate to the potential owner via third-party plug-in 311 that the object was left behind in the room.

In another example, when image analysis 323 identifies an empty chair and the location within the room of the empty chair, AV system optimizer 315 may determine which zone the empty chair is located within and, in the case of when cameras are configured using automatic camera preset recall and designated to capture video within particular zones, AV system optimizer 315 may communicate with the camera configured to capture video data within the particular zone the empty chair is located within to be disabled until someone enters the particular zone.

Each of core processor 310, display 340, microphone 350, camera 360, and AI accelerator 390 may communicate via a point-to-point communications (e.g., HDMI, USB, UVC, and so on), over a network protocol (e.g., Transmission Control Protocol/Internet Protocol, Wi-Fi, and the like), or some combination. Further, core processor 310, cloud platform 320, AI accelerator 390 may communicate over network protocol.

FIG. 4 is a flow diagram illustrating an overview of an environment in which embodiments of the present technology can operate. Environment 400 may include at least one network camera 402 (e.g., camera 360), a plug-in 403 (e.g., third-party plug-in 311), a context monitor 416; and an AI accelerator 408 that comprises a video processing pipeline 404, video engine 406 (e.g., video engines 317, 391), AI services 409, and an application program interface 414. Environment 400 further includes a cloud platform 410 (e.g., cloud platform 323) that includes a vision engine 421 (e.g., vision engine 321) comprising an image analysis 423 (e.g., image analyzer 323), a face detector 424 (e.g., face detector 324), object character recognition 425 (e.g., object character recognition 325), and object detector and image context 426 (e.g., object detector 326); and a corporate directory 412 (e.g., third-party application 370).

### Initialization and Camera Feed Acquisition

One non-limiting example of the present disclosure may include initializing network cameras 402. Network cameras 402 may provide an RTSP (Real-Time Streaming Protocol) feed. This RTSP feed may be ingested into a video processing pipeline 404, which can run on any of AI accelerator 408 (e.g., AI accelerator 390), a processing core (e.g., processing core 310), or cloud platform 410 depending on the application size and requirements.

### Video Pipeline and Frame Conversion

Video pipeline 404 may use a GStreamer library, a versatile multimedia framework, to manage the RTSP feed. The continuous video feed is formatted and converted into individual frames (e.g., JPG images) at a rate of, for example, 30 frames per second. This conversion may be crucial for enabling real-time image processing. Video pipeline 404 may perform all necessary conversions within this framework, ensuring that each frame is ready for subsequent analysis.

### Image Processing and Analysis

The individual frames may be processed by video engine 406 on AI accelerator 408. Video engine 406 may send these frames (e.g., frame images, thumbnail images, and the like) to AI services 409 that may act as an interface to applications/services provided by cloud platform 410 for various types of analysis (as discussed above with reference to FIG. 3): facial detection (e.g., by face detector 324): identifies and captures faces within the image frames, thumbnail images, and the like to determine if there are face(s) present; Optical Character Recognition (OCR) (e.g., optical character recognition 325): extracts text from the images, which can be useful for identifying written information; Image Analysis (e.g., image analysis 323): This includes several sub-processes (as described with reference to FIG. 3): Captioning Information: Generates descriptive captions for the images. Object Detection: Identifies and tags objects within the images. Visual Tags: Applies tags to recognized items, which can include objects, people, or other notable features within the frames.

### User Information Retrieval

Further, according to technical aspects of the present disclosure, the system may request user information from corporate directory 412 via application program interface 414. The requested information includes usernames, email addresses, and thumbnail photos of users. This information is temporarily pulled and used for comparison with the analyzed image data.

### Comparison and Matching

The results from AI services 409 and/or cloud platform 410 are compared with the user information retrieved from corporate directory 412. If a face detected in an image frame matches a face from the user information, the system (e.g., corporate identity matcher 312) confirms the identity of the person. This matching process ensures that the system can accurately identify individuals based on the visual data and corporate directory 412 user information.

### Result Distribution

The matched results may be distributed to two primary destinations: context monitor 416 (e.g., display 130, 340, etc.) that displays the analyzed data in real-time, providing immediate feedback and insights; and plug-in 403 designed to integrate with a core processor (e.g., core processor 310), allowing for further processing and actions based on the analyzed data.

Technical aspects of the present disclosure may provide additional functionalities. For example, the system can adjust camera presets based on occupancy or object status, as discussed above. For example, the system can change camera angles or zoom levels depending on the number of people detected in a room. It can also detect and notify users about objects left behind in a room. By analyzing the last known occupants and the objects present, the system can send notifications to users if items like backpacks are left behind. This functionality is particularly useful for ensuring that personal belongings are not forgotten and can be promptly returned to their owners.

### System Flexibility and Scalability

The system, and components therein, is/are designed to be flexible, capable of running on either a core processor (e.g., core processor 310) for smaller applications or AI accelerator 408 for larger, more demanding applications. This scalability ensures that the system can be adapted to various environments and use cases, from small meeting rooms to large conference halls. Potential applications include security monitoring, automated attendance tracking, and enhanced meeting room management.

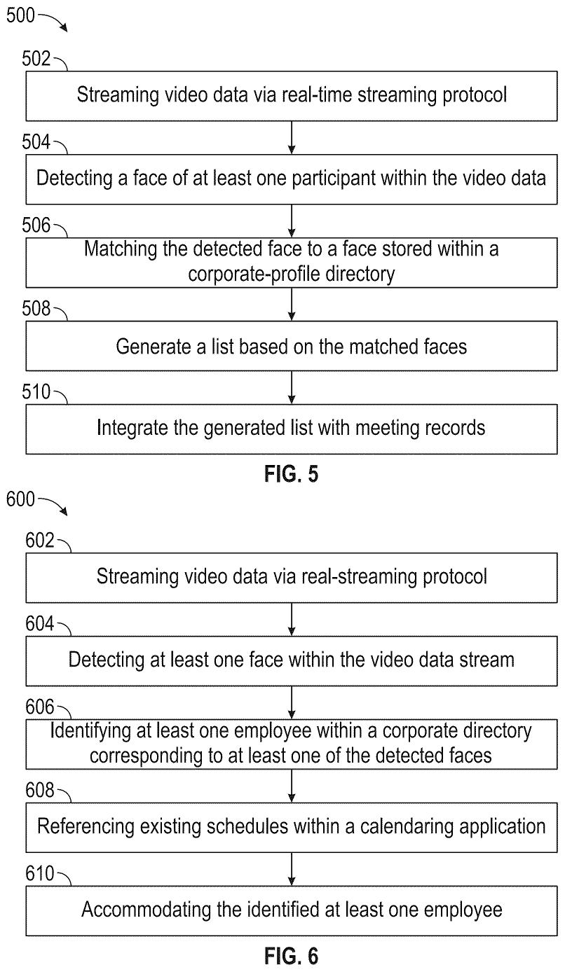

FIG. 5 is a flowchart illustrating a method for generating a list of occupants within a room, according to technical aspects of the present disclosure. Method 500 may include streaming (502) video data via a real-time streaming protocol. Method 500 may further include detecting (504) a face of at least one participant within the video data. Method 500 may further include matching (506) the detected face to a face stored within a corporate-profile directory. Method 500 may further include generating (508) a list based on the matched faces. Method 500 may further include integrating (510) the generated list with meeting records.

FIG. 6 is a flowchart illustrating a method for adjusting a room booking system, according to technical aspects of the present disclosure. Method 600 includes streaming (602) video data via real-streaming protocol. Method 600 further includes detecting (604) at least one face within the video data stream. Method 600 includes identifying (606) at least one employee within a corporate directory corresponding to at least one of the detected faces. Method 600 further includes referencing (608) existing schedules within a calendaring application. Method 600 includes accommodating (610) the identified at least one employee.

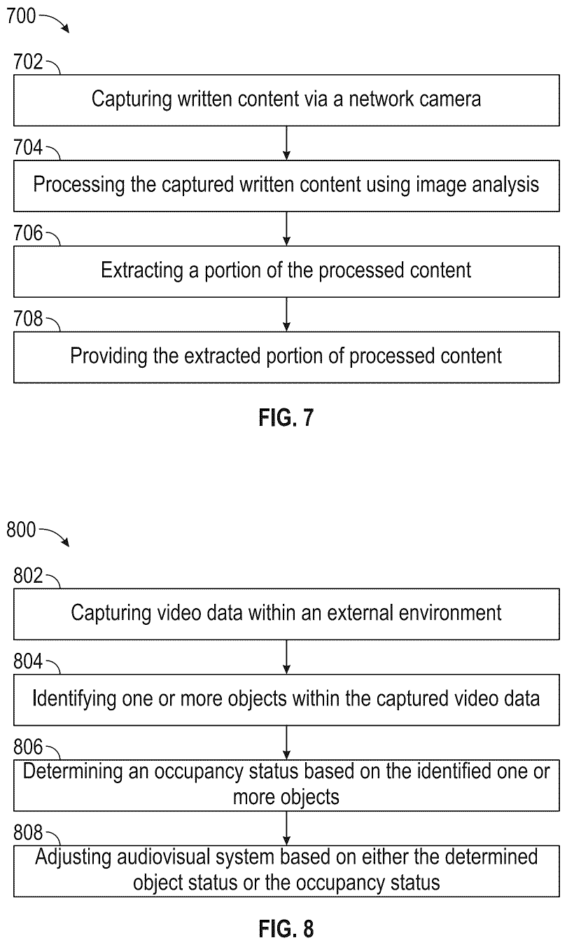

FIG. 7 is a flowchart illustrating a method for providing written content to at least one individual, according to technical aspects of the present disclosure. Method 700 includes capturing (702) written content via a network camera. Method 700 further includes processing (704) the captured written content using image analysis. Method 700 includes extracting (706) a portion of the processed content. Method 700 further includes providing (708) the extracted portion of processed content to at least one individual.

FIG. 8 is a flowchart illustrating a method for adjusting settings and configurations of an audiovisual system, according to technical aspects of the present disclosure. Method 800 includes capturing (802) video data within an external environment. Method 800 further includes identifying (804) one or more objects within the captured video data. Method 800 includes determining (806) an occupancy status based on the identified one or more objects. Method 800 further includes adjusting (808) audiovisual system based on either the determined object status or the occupancy status.

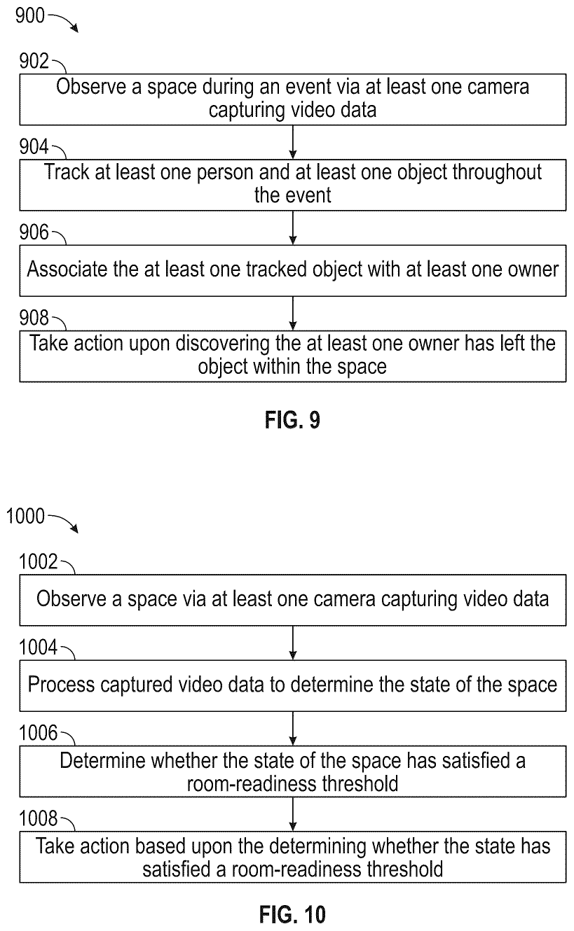

FIG. 9 is a flowchart illustrating a method for detecting an object and an associated owner of the object, that may be used for loss prevention, according to technical aspects of the present disclosure. Method 900 includes observing (902) a space during an event via at least one camera (e.g., camera 360) capturing video data. Method 900 further includes tracking (904) at least one person and at least one object throughout the event. Method 900 further includes associating (906) the at least one tracked object with at least one owner (e.g., the person). Method 900 further includes taking (908) action upon discovering the at least one owner has left the object within the space. In one example of block 908, lost item detector 319 may notify (e.g., transmit a message via text, email, and the like) that the object has been left behind within the space. In another example of block 908, lost item detector 319 notifies a facility management system that the object has been left behind. In yet another example of block 908, lost item detector 319 may flag, for example, by sending room scheduler 313 a notification that the room is not ready for use and/or a notification to room preparer 318 that the room is not ready for use and the reason why: there is an object left behind and the owner (e.g., the CEO, president, executive, etc.) of the object.

FIG. 10 is a flowchart illustrating a method for determine whether a space is sufficiently ready for an upcoming meeting, according to technical aspects of the present disclosure. Method 1000 may include observing (1002) a space via at least one camera capturing video data. Method 1000 may include processing (1004) the captured video data to determine whether the state of the space. In one example of block 1004, LLM 385 may determine, based on training data and a specific criteria and factors, as discussed above, the state of the room. Method 1000 may include determining (1006) whether the state of the space has satisfied a room-readiness threshold. Method 1000 may include taking (1008) action based upon the determining whether the determined state has satisfied the room-readiness threshold.

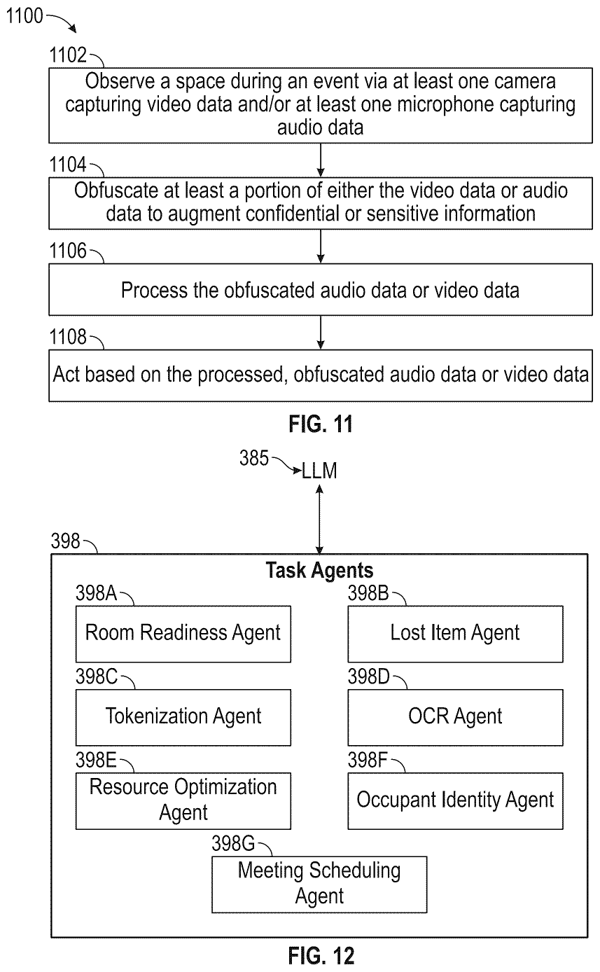

FIG. 11 is a flowchart illustrating a method for acting based on obfuscated audio data or video data, according to technical aspects of the present disclosure. Method 1100 may include observing (1102) a space during an event via at least one camera capturing video data and/or at least one microphone capturing audio data. Method 1100 may further include obfuscating (1104) at least a portion of either the video data or audio data to augment confidential or sensitive information. Method 1100 further includes processing (1106) the obfuscated audio data or video data. Method 1100 further includes acting (1108) based on the processed, obfuscated audio data or video data.

FIG. 12 is a block diagram illustrating an LLM-based task agent used in conjunction with the system of FIG. 3, in accordance with certain illustrative embodiments of the present disclosure. In the embodiment of FIG. 12, and with reference to the system architecture described in FIG. 3, LLM 385 functions as room agent 385, a centralized, intelligent coordinator that interfaces with both the user and a set of specialized task agents 398, each represented by a dedicated large language model or similarly capable AI module. Room agent 385 serves as the front-facing control point for the audiovisual system, receiving user input via voice, text, touchscreen interfaces or otherwise and interpreting the user's intent to determine the appropriate system response. Based on the requested task, room agent 385 dynamically delegates execution to one of the task-specific agents within the task agent group 398A-398G, as described below.

This exemplary embodiment represents an agentic-style artificial intelligence architecture, in which a primary agent—room agent 385—performs reasoning, planning, and delegation in the context of a broader system. Agentic-style AI refers to an approach where AI components are designed to act as autonomous, goal-directed agents that can take initiative, decompose tasks, route decisions, and interact with other agents or subsystems to accomplish objectives. Rather than simply responding to prompts with static outputs, an agentic AI evaluates user intent, maintains context over time, and selects the appropriate sub-agents or tools to fulfill complex tasks in a modular and interpretable way.

Room readiness agent 398A is responsible for evaluating whether a room is properly prepared for an upcoming meeting. This sub-agent interfaces with components such as video engine 317, audio engine 316, and room preparer 318 to assess various readiness factors including room cleanliness, seating arrangements, whiteboard status, ambient noise conditions, and presentation material progression. For example, if a user says, “Is this room ready for the executive board meeting in 15 minutes?” room agent 385 will call room readiness agent 398A, which may evaluate camera feeds showing clutter on the table, detect that the whiteboard has leftover content from a previous meeting, and determine that the room does not meet readiness thresholds. In response, room agent 385 can notify facilities staff or recommend a nearby clean room for reassignment.

Lost item agent 398B is configured to manage the detection, tracking, and owner association of objects left behind in the environment. By communicating with camera(s) 360, object detector 326, face detector 324, distance mapper 330, and lost item detector 319, this agent calculates proximity-based ownership confidence scores and generates notifications to alert either the item's owner or facility staff. For instance, after a meeting concludes, the system may observe that a laptop remains on the conference table. Room agent 385 automatically invokes lost item agent 398B, which identifies the person who sat closest to the laptop throughout the meeting and matches that individual to a corporate identity. The agent then triggers an email and text notification to the individual stating, “Your laptop appears to have been left behind in Room 6C.”

Tokenization agent 398C is tasked with performing privacy-preserving transformations on audio and video data prior to transmission to cloud platforms. It engages video obfuscator 394 and audio obfuscator 395 to obscure sensitive information using techniques such as face anonymization, visual fogging, text redaction, or boilerplate overlays, while preserving the utility of the data for downstream processing. For example, when a user asks room agent 385 to generate a summary of a legal strategy meeting, the request is routed to tokenization agent 398C, which ensures that whiteboard content, laptop screens, and participant identities are obscured before any data is shared with external systems such as LLM 385 or cloud platform 320 for transcription or summarization.

OCR agent 398D extracts written content from visual inputs captured within the room using camera(s) 360 and optical character recognizer 325. This content is then structured and provided to content provider 314 for delivery to meeting participants or individuals whose job functions align with the subject matter. For instance, a user might ask, “Can you send me everything that was written on the whiteboard during the design review?” Room agent 385 hands off this request to OCR agent 398D, which captures and transcribes the whiteboard content, performs any necessary filtering or formatting, and routes the output to the appropriate stakeholders via email or collaboration platforms.

Resource optimization agent 398E monitors room usage and adjusts audiovisual system settings accordingly. In communication with image analyzer 323 and AV system optimizer 315, the agent detects unoccupied chairs or zones within the space and disables unnecessary camera presets or reallocates AV resources to reduce system load. For example, if a meeting is underway with only three participants clustered on one side of the table, resource optimization agent 398E may disable camera zones focused on unoccupied areas and rebalance beamforming microphones toward the active side of the room.

Occupant identity agent 398F detects and identifies individuals in the room using real-time video feeds. It works with face detector 324, corporate identity matcher 312, and room scheduler 313 to match faces to corporate profiles, generate attendance records, and synchronize data with calendaring and compliance systems. For example, when a user asks, “Who attended the strategy session at 2 p.m. yesterday?” room agent 385 calls occupant identity agent 398F, which reconstructs the attendee list from facial recognition logs and generates a report tied to the meeting record.

Meeting scheduling agent 398G dynamically manages the room booking system based on real-time occupancy data. By detecting ad-hoc meetings or unused reservations, this agent can autonomously create new meeting entries, cancel ghost bookings, or suggest alternative spaces based on size, availability, and proximity to the user. For example, if a user enters an unreserved room and begins a discussion, room agent 385 may detect occupancy and activate meeting scheduling agent 398G to schedule a temporary ad-hoc meeting with the identified participants and synchronize it to the corporate calendar system.

Each of the agents described—398A through 398G—operates semi-autonomously under the supervision and orchestration of room agent 385. The room agent determines which sub-agent should handle a given user request, initiates that handoff, and may log contextual metadata from the transaction, such as confidence scores, timestamps, or task results, into room metadata corpus 380. This ongoing data capture enables reinforcement learning and long-term performance optimization. The embodiment of FIG. 12 reflects a modular, agentic architecture in which room agent 385 provides a unified interface for user interaction while enabling distributed task execution through specialized agents. This approach improves scalability, transparency, and system responsiveness while preserving user privacy, efficient system resource allocation and supporting fine-grained control over audiovisual environment management.

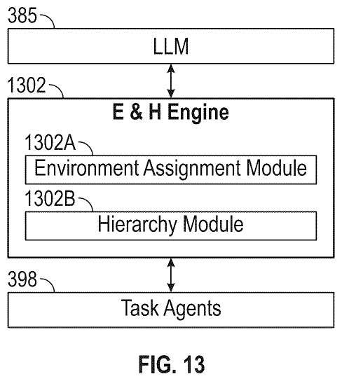

FIG. 13 is a block diagram illustrating an embodiment of an intelligence system that coordinates hierarchical sets of agents bound to physical spaces and/or functional domains, in accordance with the present disclosure. The intelligence system of FIG. 13 may be used in conjunction with any of the other system architectures described herein. In this embodiment, LLM 385 may act as a room agent, while the task agents 398A-398G may operate as the plurality of task-specific large language models (LLMs), as described previously with respect to FIG. 12. Further, either of LLM 385 or task agents 398 may collectively form the hierarchical set of agents, with any of the agents 398 or LLM 385 (jointly referred to as “hierarchical agents”) capable of acting as either a supervisory agent or a subordinate agent, depending on context and configuration.

Referring to FIG. 13, an Environment and Hierarchy (E & H) Engine 1302 is provided to coordinate the assignment, management, and communication among hierarchical agents. E & H Engine 1302 facilitates bidirectional communication with both LLM 385 and task agents 398, enabling coordination across multiple physical spaces and functional domains. The E & H Engine 1302 includes two primary submodules: an environment assignment module 1302A and a hierarchy module 1302B. Further, note any of LLM 385, E & H engine 1302 or task agents 398 may be located on a cloud network.

In operation, environment assignment module 1302A is configured to assign any of the hierarchical set of agents—including LLM 385 or any of task agents 398—as a room agent bound to a specific physical environment. The physical environment may correspond to a discrete space, such as a conference room, office, laboratory, or building floor. Binding an agent to a physical environment establishes a direct correspondence between the software-based intelligence and the peripherals (e.g., physical sensors and control systems) within that space. The environment assignment module 1302A can also assign a hierarchical agent to a functional domain rather than a discrete physical space. Functional domains may include, for example, HVAC control across multiple floors, lighting management within an entire building, or energy optimization across a campus. Functional tasks may include any task related to these functional domain, in addition to readiness assessments, lost item detection, tokenization, OCR, audiovisual resource optimization, occupant identification or meeting scheduling, for example.

Once an assignment is made, the bound agent (e.g., room agent or function-specific agent) is responsible for monitoring and acting within its assigned domain. Monitoring may include receiving and processing data from associated sensors-such as temperature sensors, occupancy sensors, air-quality sensors, cameras, or microphones-while acting may involve invoking connected control systems to adjust parameters such as HVAC set points, lighting levels, or audiovisual system states.

Hierarchy module 1302B establishes and maintains the nested supervisory relationships among hierarchical agents. For example, a room agent assigned to a single conference room may operate as a subordinate agent to a floor-level supervisory agent that manages a plurality of room agents on the same floor. Similarly, a building-level supervisory agent may oversee multiple floor agents, coordinating environmental conditions and system resources across a broader scope. In certain configurations, LLM 385 may operate as a supervisory agent coordinating multiple task agents 398, while in other configurations one of task agents 398—such as a resource optimization agent—may act as the supervisory agent within a specific functional domain.

Through E & H engine 1302, hierarchical coordination is maintained in real time. The bidirectional communication pathways allow supervisory agents to propagate control policies, operating thresholds, and contextual data downward to subordinate agents, while subordinate agents transmit sensor telemetry, status updates, and execution results upward, for example. This architecture allows the overall system to maintain a distributed awareness of both local and global conditions across rooms, floors, and buildings, enabling coordinated responses and adaptive optimization.

By employing the E & H engine 1302 in conjunction with LLM 385 and task agents 398, the system provides a scalable, multi-tiered agentic architecture capable of both autonomous local control and coordinated global management. The framework enables each agent to reason and act within its assigned scope while remaining aware of higher-level objectives communicated through the hierarchy. As a result, the system achieves improved scalability, context retention, and cross-domain coordination across complex physical environments.

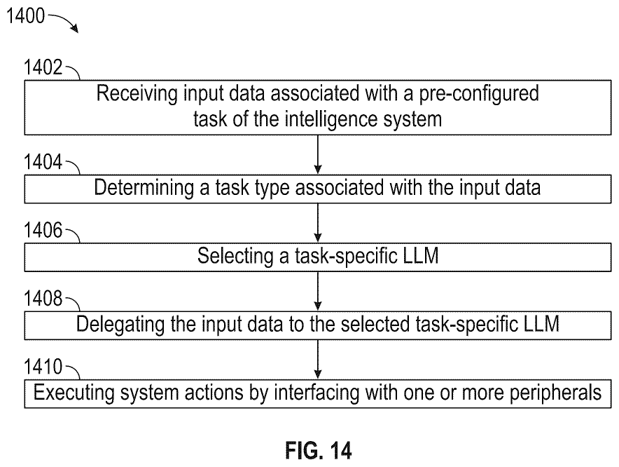

FIG. 14 is a flow chart of a method for coordinating tasks within an environment using an agentic artificial intelligence system, according to certain illustrative embodiments of the present disclosure. In method 1400, the intelligence system executes instructions for analyzing input data received by the system. The input data may be a variety of inputs related to user requests or other functions/tasks in which the intelligence system has been preconfigured to complete. The intelligence system monitors the environment for indicia that relates to its preconfigured tasks, such as, for example marks on a whiteboard—which may be confidential—and can reference, for example, a calendaring application that details when time and location of the next meeting. In other embodiments, a formal user request to the system is not necessary; rather, the system can automatically determine that a new meeting is starting in five minutes and then determines whether the room is clean and takes action to clean the room if it is not clean (e.g., sending notice to a system which alerts a cleaning crew). Thus, the intelligence system has agency to determine when to act on its own, in addition to responding to direct user requests/instructions.

At block 1402, the system receives, by a first large language model (LLM) operating as a room agent, input data associated with a preconfigured task of the intelligence system. Such preconfigured tasks may be any of the tasks described herein. At block 1404, the system determines, by the room agent, a task type associated with the input data. At block 1406, the system then selects, by the room agent and based on the task type, a task-specific LLM from a plurality of task-specific LLMs. AT block 1408, the system delegates, by the room agent, the input data to the selected task-specific LLM. At block 1410, the system then executes, by the selected task-specific LLM, one or more system actions by interfacing with one or more peripherals associated with the environment. Such peripherals may comprise, for example, any such peripherals discussed herein.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately” and “about” are used herein to mean within at least within 10% of a given value or limit. Purely by way of example, an approximate ratio means within 10% of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Methods and embodiments described herein further relate to any one or more of the following paragraphs:
1. A computer-implemented method for coordinating tasks within an environment using an agentic artificial intelligence system, the method comprising: executing instructions for analyzing input data received by the system; receiving, by a first large language model (LLM) operating as a room agent, input data associated with a preconfigured task of the intelligence system; determining, by the room agent, a task type associated with the input data; selecting, by the room agent and based on the task type, a task-specific LLM from a plurality of task-specific LLMs; delegating, by the room agent, the input data to the selected task-specific LLM; and executing, by the selected task-specific LLM, one or more system actions by interfacing with one or more peripherals associated with the environment.
2. The computer-implemented method as defined in paragraph 1, wherein the task-specific LLMs comprise: a room readiness agent configured to determine a readiness status of the environment; a lost item agent configured to identify an object left behind and associate the object with a likely owner; or a tokenization agent configured to obfuscate sensitive audio and video content prior to external processing.
3. The computer-implemented method as defined in paragraphs 1 or 2, wherein the task-specific LLMs comprise: an optical character recognition (OCR) agent configured to extract and distribute written content from captured video data; a resource optimization agent configured to detect unused zones and adjust audiovisual resources accordingly; an occupant identity agent configured to detect and identify individuals within the environment; or a meeting scheduling agent configured to create or update meeting entries based on real-time room occupancy.
4. The computer-implemented method as defined in any of paragraphs 1-3, wherein the room agent is bound to a physical environment; and configured to monitor the bounded physical environment using one or more peripheral devices positioned therein.
5. The computer-implemented method as defined in any of paragraphs 1-4, wherein: the plurality of task-specific LLMs and room agent form a hierarchical set of agents; any of the room agent or task-specific LLMs can act as a supervisory agent or a subordinate agent; the supervisory agent is configured to coordinate operations across one or more physical environments or functional domains, and the subordinate agent is configured to act within an assigned physical environment or to perform a functional task.
6. The computer-implemented method as defined in any of paragraphs 1-5, wherein the room agent operates as a supervisory agent and at least one of the task-specific LLMs operates as a subordinate agent configured to perform a functional task.
7. The computer-implemented method as defined in any of paragraphs 1-6, wherein the functional task is a specialized task comprising at least one of readiness assessment, lost item detection, tokenization, OCR, audiovisual resource optimization, occupant identification, or meeting scheduling.
8. A system for coordinating tasks within an environment using an agentic artificial intelligence system, the system comprising: one or more peripherals associated with the environment; and processing circuitry configured to perform operations comprising: executing instructions for analyzing input data received by the system; receiving, by a first large language model (LLM) operating as a room agent, input data associated with a preconfigured task of the intelligence system; determining, by the room agent, a task type associated with the input data; selecting, by the room agent and based on the task type, a task-specific LLM from a plurality of task-specific LLMs; delegating, by the room agent, the input data to the selected task-specific LLM; and executing, by the selected task-specific LLM, one or more system actions by interfacing with the one or more peripherals associated with the environment.
9. The system as defined in paragraph 8, wherein the task-specific LLMs comprise: a room readiness agent configured to determine a readiness status of the environment; a lost item agent configured to identify an object left behind and associate the object with a likely owner; or a tokenization agent configured to obfuscate sensitive audio and video content prior to external processing.
10. The system as defined in paragraphs 8 or 9, wherein the task-specific LLMs comprise: an optical character recognition (OCR) agent configured to extract and distribute written content from captured video data; a resource optimization agent configured to detect unused zones and adjust audiovisual resources accordingly; an occupant identity agent configured to detect and identify individuals within the environment; or a meeting scheduling agent configured to create or update meeting entries based on real-time room occupancy.
11. The system as defined in any of paragraphs 8-10, wherein the room agent is: bound to a physical environment; and configured to monitor the bounded physical environment using one or more peripheral devices positioned therein.
12. The system as defined in any of paragraphs 8-11, wherein: the plurality of task-specific LLMs and room agent form a hierarchical set of agents; any of the room agent or task-specific LLMs can act as a supervisory agent or a subordinate agent; the supervisory agent is configured to coordinate operations across one or more physical environments or functional domains, and the subordinate agent is configured to act within an assigned physical environment or to perform a functional task.
13. The system as defined in any of paragraphs 8-12, wherein the room agent operates as a supervisory agent and at least one of the task-specific LLMs operates as a subordinate agent configured to perform a functional task.
14. The system as defined in any of paragraphs 8-13, wherein the functional task is a specialized task comprising at least one of readiness assessment, lost item detection, tokenization, OCR, audiovisual resource optimization, occupant identification, or meeting scheduling.

Moreover, the methods described herein may be embodied within a non-transitory computer-readable medium comprising instructions which, when executed by the processor/processing circuitry, causes the processor to perform any of the methods described herein.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

1. A computer-implemented method for coordinating tasks within an environment using an agentic artificial intelligence system, the method comprising:
executing instructions for analyzing input data received by the system;
receiving, by a first large language model (LLM) operating as a room agent, input data associated with a preconfigured task of the intelligence system;
determining, by the room agent, a task type associated with the input data;
selecting, by the room agent and based on the task type, a task-specific LLM from a plurality of task-specific LLMs;
delegating, by the room agent, the input data to the selected task-specific LLM; and
executing, by the selected task-specific LLM, one or more system actions.

2. The computer-implemented method as defined in claim 1, wherein the task-specific LLMs comprise:
a room readiness agent configured to determine a readiness status of the environment;
a lost item agent configured to identify an object left behind and associate the object with a likely owner; or
a tokenization agent configured to obfuscate sensitive audio and video content prior to external processing.

3. The computer-implemented method as defined in claim 1, wherein the task-specific LLMs comprise:
an optical character recognition (OCR) agent configured to extract and distribute written content from captured video data;
a resource optimization agent configured to detect unused zones and adjust audiovisual resources accordingly;
an occupant identity agent configured to detect and identify individuals within the environment; or
a meeting scheduling agent configured to create or update meeting entries based on real-time room occupancy.

4. The computer-implemented method as defined in claim 1, wherein the room agent is:
bound to a physical environment; and
configured to monitor the bounded physical environment using one or more peripheral devices positioned therein.

5. The computer-implemented method as defined in claim 1, wherein:
the plurality of task-specific LLMs and room agent form a hierarchical set of agents;
any of the room agent or task-specific LLMs can act as a supervisory agent or a subordinate agent;
the supervisory agent is configured to coordinate operations across one or more physical environments or functional domains, and
the subordinate agent is configured to act within an assigned physical environment or to perform a functional task.

6. The computer-implemented method as defined in claim 5, wherein the room agent operates as a supervisory agent and at least one of the task-specific LLMs operates as a subordinate agent configured to perform a functional task.

7. The computer-implemented method as defined in claim 6, wherein the functional task is a specialized task comprising at least one of readiness assessment, lost item detection, tokenization, OCR, audiovisual resource optimization, occupant identification, or meeting scheduling.

8. A system for coordinating tasks within an environment using an agentic artificial intelligence system, the system comprising:
one or more peripherals associated with the environment; and
processing circuitry configured to perform operations comprising:
executing instructions for analyzing input data received by the system;
receiving, by a first large language model (LLM) operating as a room agent, input data associated with a preconfigured task of the intelligence system;
determining, by the room agent, a task type associated with the input data;
selecting, by the room agent and based on the task type, a task-specific LLM from a plurality of task-specific LLMs;
delegating, by the room agent, the input data to the selected task-specific LLM; and
executing, by the selected task-specific LLM, one or more system actions.

9. The system as defined in claim 8, wherein the task-specific LLMs comprise:
a room readiness agent configured to determine a readiness status of the environment;
a lost item agent configured to identify an object left behind and associate the object with a likely owner; or
a tokenization agent configured to obfuscate sensitive audio and video content prior to external processing.

10. The system as defined in claim 8, wherein the task-specific LLMs comprise:
an optical character recognition (OCR) agent configured to extract and distribute written content from captured video data;
a resource optimization agent configured to detect unused zones and adjust audiovisual resources accordingly;
an occupant identity agent configured to detect and identify individuals within the environment; or
a meeting scheduling agent configured to create or update meeting entries based on real-time room occupancy.

11. The system as defined in claim 8, wherein the room agent is:
bound to a physical environment; and
configured to monitor the bounded physical environment using one or more peripheral devices positioned therein.

12. The system as defined in claim 8, wherein:
the plurality of task-specific LLMs and room agent form a hierarchical set of agents;
any of the room agent or task-specific LLMs can act as a supervisory agent or a subordinate agent;
the supervisory agent is configured to coordinate operations across one or more physical environments or functional domains, and
the subordinate agent is configured to act within an assigned physical environment or to perform a functional task.

13. The system as defined in claim 12, wherein the room agent operates as a supervisory agent and at least one of the task-specific LLMs operates as a subordinate agent configured to perform a functional task.

14. The system as defined in claim 13, wherein the functional task is a specialized task comprising at least one of readiness assessment, lost item detection, tokenization, OCR, audiovisual resource optimization, occupant identification, or meeting scheduling.

15. A non-transitory computer-readable storage medium storing instructions that, when executed by an intelligence system, cause the computing system to perform operations comprising:
executing instructions for analyzing input data received by the intelligence system;
receiving, by a first large language model (LLM) operating as a room agent, input data associated with a preconfigured task of the intelligence system;
determining, by the room agent, a task type associated with the input data;
selecting, by the room agent and based on the task type, a task-specific LLM from a plurality of task-specific LLMs;
delegating, by the room agent, the input data to the selected task-specific LLM; and
executing, by the selected task-specific LLM, one or more system actions.

16. The computer-readable storage medium as defined in claim 15, wherein the task-specific LLMs comprise:
a room readiness agent configured to determine a readiness status of the environment;
a lost item agent configured to identify an object left behind and associate the object with a likely owner; or
a tokenization agent configured to obfuscate sensitive audio and video content prior to external processing.

17. The computer-readable storage medium as defined in claim 15, wherein the task-specific LLMs comprise:
an optical character recognition (OCR) agent configured to extract and distribute written content from captured video data;
a resource optimization agent configured to detect unused zones and adjust audiovisual resources accordingly;
an occupant identity agent configured to detect and identify individuals within the environment; or
a meeting scheduling agent configured to create or update meeting entries based on real-time room occupancy.

18. The computer-readable storage medium as defined in claim 15, wherein the room agent is:
bound to a physical environment; and
configured to monitor the bounded physical environment using one or more peripheral devices positioned therein.

19. The computer-readable storage medium as defined in claim 15, wherein:
the plurality of task-specific LLMs and room agent form a hierarchical set of agents;
any of the room agent or task-specific LLMs can act as a supervisory agent or a subordinate agent;
the supervisory agent is configured to coordinate operations across one or more physical environments or functional domains, and
the subordinate agent is configured to act within an assigned physical environment or to perform a functional task.

20. The computer-readable storage medium as defined in claim 19, wherein the room agent operates as a supervisory agent and at least one of the task-specific LLMs operates as a subordinate agent configured to perform a functional task.
